(19) United States
(12) Patent Application Publication
(10) Pub. No.: US 2012/0073123 A1
(43) Pub. Date: Mar. 29, 2012

(54) Method of manufacturing thermal head

(76) Inventors: Noriyoshi Shoji, Chiba-shi (JP); Norimitsu Sanbongi, Chiba-shi (JP); Toshimitsu Morooka, Chiba-shi (JP); Keitaro Koroishi, Chiba-shi (JP)

(21) Appl. No.: 13/200,251

(22) Filed: Sep. 21, 2011

(30) Foreign Application Priority Data
Sep. 24, 2010 (JP) 2010-213291

(51) Int. Cl. H01C 17/00

(52) U.S. Cl. 29/610.1

(57) ABSTRACT

A method of manufacturing a thermal head, comprising: forming a concave portion opened in one surface of a support substrate and an upper substrate to be disposed on the support substrate in a stacked state, the support substrate and the upper substrate each being of a plate shape; a step of measuring a width dimension of the concave portion formed in the concave portion forming step; bonding the support substrate and the upper substrate to each other in the stacked state so as to close an opening of the concave portion; thinning the upper substrate bonded onto the support substrate in the bonding, to a thickness set based on the width dimension of the concave portion measured in the measuring; and forming a heating resistor on a surface of the thinned upper substrate in a region opposed to the concave portion.

### BACKGROUND OF THE INVENTION

1. Field of the Invention

The present invention relates to a method of manufacturing a thermal head.

2. Description of the Related Art

There has been conventionally known a method of manufacturing a thermal head for use in thermal printers (see, for example, Japanese Patent Application Laid-open No. 2010-94939). In the method of manufacturing a thermal head described in Japanese Patent Application Laid-open No. 2010-94939, a concave portion is formed in one surface of an upper substrate, and a support substrate is bonded onto the upper substrate so as to close the concave portion, and after that, heating resistors are formed on a rear surface of the upper substrate in a region opposed to the concave portion, to thereby manufacture a thermal head which has a cavity portion between the upper substrate and the support substrate.

In the thermal head manufactured in this way, the cavity portion functions as a heat-insulating layer of low thermal conductivity to reduce an amount of heat transferring from the heating resistors toward the support substrate side via the upper substrate, to thereby increase an amount of heat to be utilized for printing and increase heating efficiency. The heating efficiency is determined by the dimensions of the concave portion, the thickness dimension of the upper substrate between the heating resistors and the cavity portion, and the like. It is therefore required to reduce fluctuations in such dimensions.

However, in manufacturing the thermal heads, there may be fluctuations in dimensions of the concave portions in the same substrate or fluctuations in dimensions of the concave portions among the substrates. Therefore, the conventional manufacturing method has a problem that fluctuations in heating efficiency cannot be suppressed and it is difficult to manufacture a thermal head having stable quality.

### SUMMARY OF THE INVENTION

The present invention has been made in view of the above-mentioned circumstances, and it is an object thereof to provide a method capable of manufacturing a thermal head having high heating efficiency and stable quality.

In order to achieve the above-mentioned object, the present invention provides the following measures.

The present invention provides a method of manufacturing a thermal head, including: forming a groove portion, which is opened in one surface of at least one of a first substrate and a second substrate to be disposed on the first substrate in a stacked state, the first substrate and the second substrate each being of a plate shape; measuring a width dimension of the groove portion formed in the forming of the groove portion; bonding the first substrate and the second substrate to each other in the stacked state so as to close an opening of the groove portion formed in the forming of the groove portion; thinning the second substrate, which is bonded onto the first substrate in the bonding, to a thickness set based on the width dimension of the groove portion measured in the measuring; and forming a heating resistor on a surface of the second substrate, which is thinned in the thinning, in a region opposed to the groove portion.

According to the present invention, the groove portion, which is formed in the groove portion forming step, is closed by bonding the first substrate and the second substrate to each other in the stacked state in the bonding step, to thereby form a stacked substrate having a cavity portion at a stacked portion between the first substrate and the second substrate. Further, the heating resistor, which is formed in the resistor forming step, is disposed so as to be opposed to the groove portion, and hence the cavity portion functions as a hollow heat-insulating layer that prevents heat from transferring toward the first substrate side from the heating resistor via the second substrate, to thereby increase heating efficiency.

In this case, the heating efficiency is determined by the dimensions of the groove portion, the thickness of the second substrate (distance from the heating resistor to the cavity portion), and the like. In the present invention, the thickness of the second substrate to be thinned in the thinning step is set based on the width dimension of the groove portion measured in the measuring step. Accordingly, fluctuations in width dimension of the groove portion can be cancelled through adjustment to the thickness of the second substrate. This reduces the occurrence of a defective, and thus a thermal head having high heating efficiency and stable quality can be manufactured.

The present invention provides a method of manufacturing a thermal head, including: forming a groove portion, which is opened in one surface of at least one of a first substrate and a second substrate to be disposed on the first substrate in a stacked state, the first substrate and the second substrate each being of a plate shape; measuring a depth dimension of the groove portion formed in the forming of the groove portion; bonding the first substrate and the second substrate to each other in the stacked state so as to close an opening of the groove portion formed in the forming of the groove portion; thinning the second substrate, which is bonded onto the first substrate in the bonding, to a thickness set based on the depth dimension of the groove portion measured in the measuring; and forming a heating resistor on a surface of the second substrate, which is thinned in the thinning, in a region opposed to the groove portion.

According to the present invention, the thickness of the second substrate to be thinned in the thinning step is set based on the depth dimension of the groove portion measured in the measuring step. Accordingly, fluctuations in depth dimension of the groove portion can be cancelled through adjustment to the thickness of the second substrate. Therefore, a thermal head having high heating efficiency and stable quality can be manufactured.

The present invention provides a method of manufacturing a thermal head, including: forming a groove portion, which is opened in one surface of at least one of a first substrate and a second substrate to be disposed on the first substrate in a stacked state, the first substrate and the second substrate each being of a plate shape; measuring a width dimension and a depth dimension of the groove portion formed in the forming of the groove portion; bonding the first substrate and the second substrate to each other in the stacked state so as to close an opening of the groove portion formed in the forming of the groove portion; thinning the second substrate, which is bonded onto the first substrate in the bonding, to a thickness set based on the width dimension and the depth dimension of the groove portion measured in the measuring; and forming a heating resistor on a surface of the second substrate, which is thinned in the thinning, in a region opposed to the groove portion.

According to the present invention, the thickness of the second substrate is set based on the width dimension and the depth dimension of the groove portion. Accordingly, fluctuations in dimensions of the groove portion can be cancelled with good accuracy through adjustment to the thickness of the second substrate. Therefore, a thermal head having high heating efficiency and high quality can be manufactured.

The present invention provides the effect that a thermal head having high heating efficiency and stable quality can be manufactured.

### BRIEF DESCRIPTION OF THE DRAWINGS

In the accompanying drawings:

FIG. 1 is a schematic structural view of a thermal head viewed in a thickness direction according to an embodiment of the present invention;

FIG. 2 is a cross-sectional view of the thermal head taken along the line A-A of FIG. 1;

FIG. 3A is a view of a large-size stacked substrate viewed in the thickness direction which is used in a method of manufacturing a thermal head according to the embodiment of the present invention, and FIG. 3B is a view of the stacked substrate of FIG. 3A viewed in a longitudinal direction;

FIG. 4 is a flowchart illustrating the method of manufacturing a thermal head according to the embodiment of the present invention;

FIG. 5A is a ranking table related to a width dimension of a concave portion, and FIG. 5B is a ranking table related to a depth dimension of the concave portion;

FIG. 6 is a table showing target values of an upper substrate based on evaluation points of the width and the depth of the concave portion;

FIG. 7A is a table showing the relationship between the width dimension of the concave portion and thermal efficiency of the thermal head, and FIG. 7B is a line graph of FIG. 7A;

FIG. 8A is a table showing the relationship between the depth dimension of the concave portion and the thermal efficiency of the thermal head, and FIG. 8B is a line graph of FIG. 8A;

FIG. 9A is a table showing the relationship between the thickness of the upper substrate and the thermal efficiency of the thermal head, and FIG. 9B is a line graph of FIG. 9A;

FIG. 10A is a table showing basic design values of the thermal head, and FIG. 10B is a table showing the relationship between actual measurement values and heating efficiency;

FIG. 11A is a table showing another example of the basic design values of the thermal head, and FIG. 11B is a table showing the relationship between actual measurement values and the heating efficiency; and

FIG. 12A is a table showing still another example of the basic design values of the thermal head, and FIG. 12B is a table showing the relationship between actual measurement values and the heating efficiency.

### DETAILED DESCRIPTION OF THE PREFERRED EMBODIMENT

Now, a method of manufacturing a thermal head according to an embodiment of the present invention is described below with reference to the accompanying drawings.

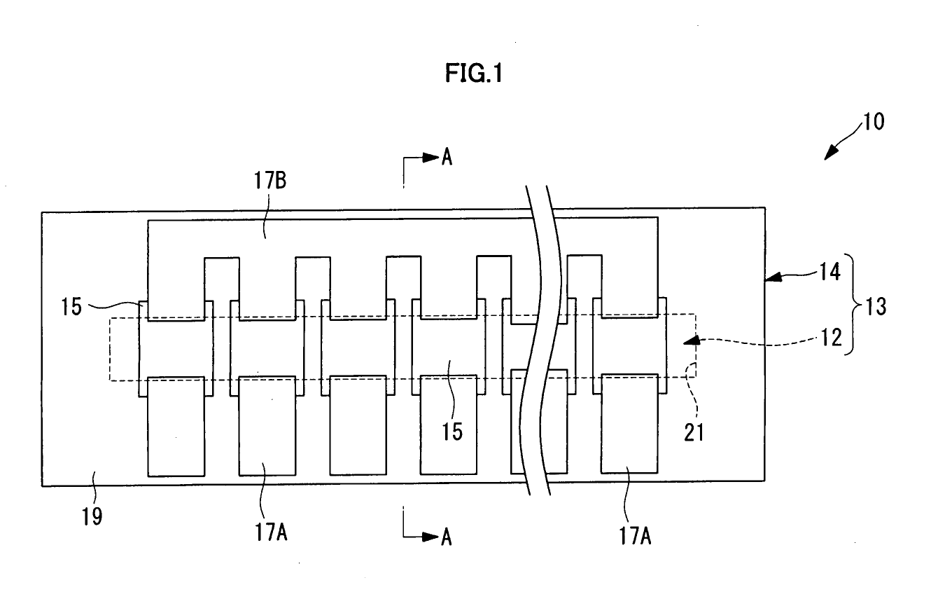

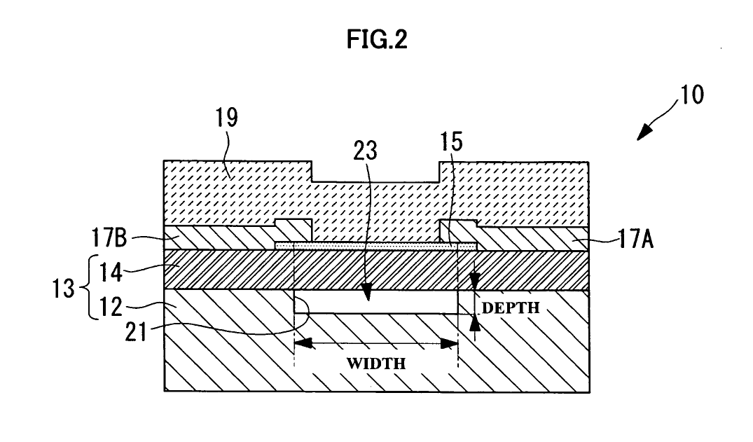

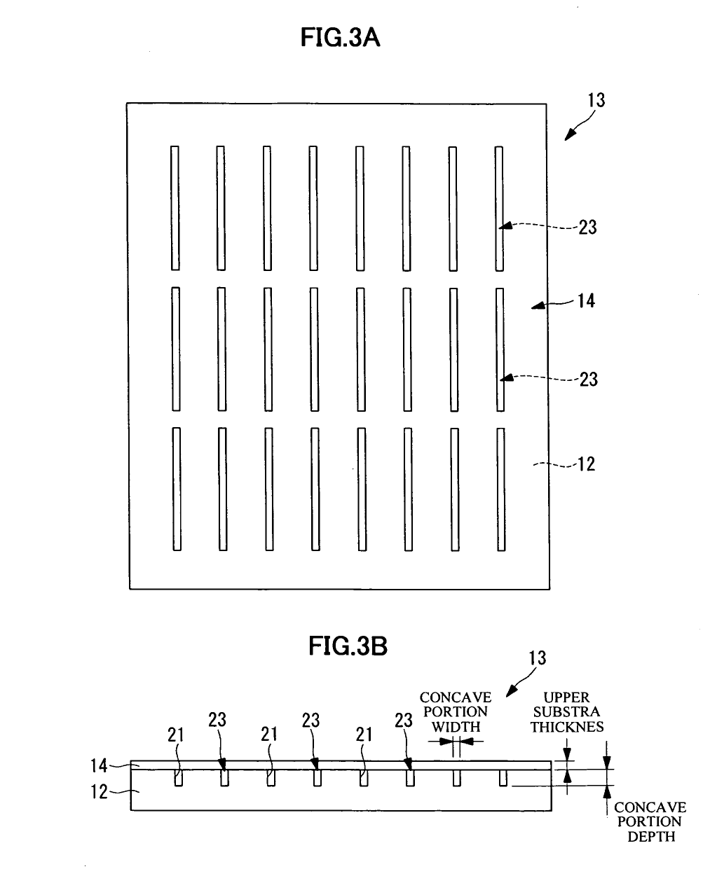

The method of manufacturing a thermal head according to this embodiment is for manufacturing, for example, as illustrated in FIGS. 1 and 2, a thermal head 10 for use in a thermal printer (not shown). In this embodiment, description is given of a method of manufacturing a plurality of thermal heads 10 from a large-size support substrate (first substrate) 12 and a large-size upper substrate (second substrate) 14 as illustrated in FIGS. 3A and 3B.

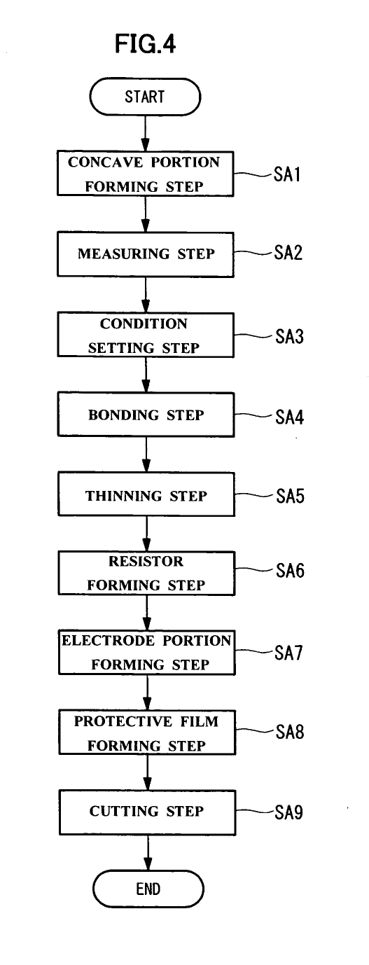

The manufacturing method of this embodiment includes, as illustrated in a flowchart of FIG. 4, a concave portion forming step (groove portion forming step) SA1 of forming a plurality of concave portions (groove portions) 21 each opened in one surface of the plate-shaped support substrate 12, a measuring step SA2 of measuring a width dimension and a depth dimension of the concave portions 21, a condition setting step SA3 of setting process conditions of the upper substrate 14, a bonding step SA4 of bonding the support substrate 12 and the upper substrate 14 to each other in a stacked state, a thinning step SA5 of thinning the upper substrate 14 bonded onto the support substrate 12, and a resistor forming step SA6 of forming heating resistors 15 on a surface of the thinned upper substrate 14.

The manufacturing method of this embodiment further includes an electrode portion forming step SA7 of forming electrode portions 17A and 17B connected to the heating resistors 15 on the surface of the upper substrate 14, a protective film forming step SA8 of forming a protective film 19 which partially covers the surface of the upper substrate 14 including the heating resistors 15 and the electrode portions 17A and 17B, and a cutting step SA9 of cutting the resultant substrate into the individual thermal heads 10.

Hereinafter, the respective steps are specifically described.

In the concave portion forming step SA1, as the support substrate 12, for example, an insulating glass substrate having a thickness approximately ranging from 300 μm to 1 mm is used. First, the large-size support substrate 12 is divided into regions for the individual thermal heads 10. For example, in FIG. 3A, the regions for the individual thermal heads 10 are rectangular regions obtained by dividing the large-size support substrate 12 into three in one direction and into eight in the other direction. In the concave portion forming step SA1, in one surface of the support substrate 12, rectangular concave portions 21 each extending in the longitudinal direction are formed in each region of the individual thermal heads 10 (Step SA1).

A larger width dimension and a larger depth dimension of the concave portions 21 are more effective in terms of thermal efficiency, but it is necessary to suppress the dimensions within a predetermined range in order to suppress fluctuations in quality among products. Further, if the width dimension of the concave portion 21 is excessively large, the strength of the upper substrate 14 is weakened. In addition, increasing the depth dimension of the concave portion 21 disadvantageously leads to an increase of manufacturing cost.

The concave portion 21 can be formed by performing, for example, sandblasting, dry etching, wet etching, laser machining, or drill machining on the one surface of the support substrate 12. When sandblasting is performed, the one surface of the support substrate 12 is covered with a photoresist material. Then, the photoresist material is exposed to light using a photomask of a predetermined pattern so as to be cured in part other than the region for forming the concave portion 21.

After that, the surface of the support substrate 12 is cleaned and the uncured photoresist material is removed. Thus, an etching mask (not shown) having an etching window formed in the region for forming the concave portion 21 can be obtained. In this state, sandblasting is performed on the surface of the support substrate 12 to form the concave portion 21 having a predetermined depth.

Further, when etching, such as dry etching and wet etching, is performed, similarly to the above-mentioned processing by sandblasting, the etching mask having the etching window formed in the region for forming the concave portion 21 is formed on the one surface of the support substrate 12. In this state, etching is performed on the surface of the support substrate 12 to form the concave portion 21 having a predetermined depth.

As such an etching process, for example, wet etching using a hydrofluoric acid-based etchant or the like is available, as well as dry etching such as reactive ion etching (RIE) and plasma etching. As a reference example, in a case of a single-crystal silicon support substrate, wet etching may be performed using an etchant such as a tetramethylammonium hydroxide solution, a KOH solution, or a mixed solution of hydrofluoric acid and nitric acid.

Next, in the measuring step SA2, for example, a measuring microscope, a contact type surface roughness tester, a non-contact type laser displacement meter, or the like is used to measure the width dimensions and the depth dimensions of the concave portions 21 (Step SA2). As to a single large-size support substrate 12, it is desired to measure the width dimensions and the depth dimensions of the plurality of concave portions 21 to calculate an average width dimension and an average depth dimension.

Next, in the condition setting step SA3, based on data on an average value of the width dimensions and an average value of the depth dimensions of the plurality of concave portions 21 measured in the measuring step SA2, process conditions of the upper substrate 14 are set (Step SA3).

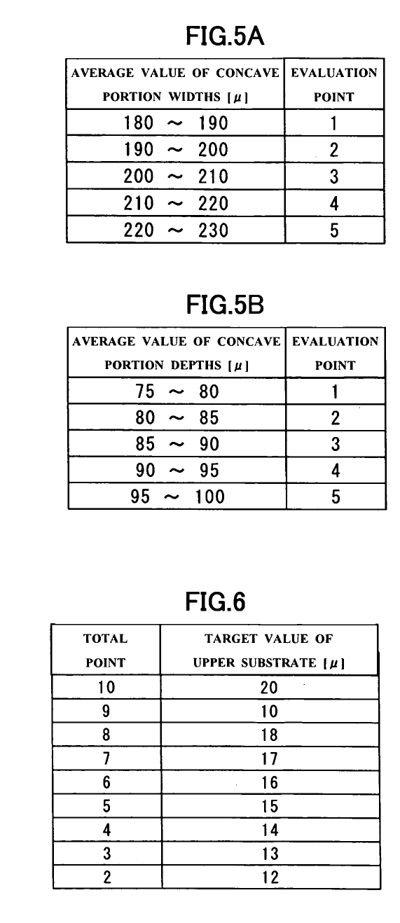

For example, a ranking table as shown in FIG. 5A in which the width dimension of the concave portion 21 is grouped by predetermined dimension intervals with evaluation points, and a ranking table as shown in FIG. 5B in which the depth dimension of the concave portion 21 is grouped by predetermined dimension intervals with evaluation points are created. Further, based on a total point of the evaluation point of the width and the evaluation point of the depth of the concave portion 21 in the ranking tables, process conditions of the upper substrate 14 as shown in FIG. 6, that is, a target value (μm) of thinning of the upper substrate 14 in the thinning step SA5 is set.

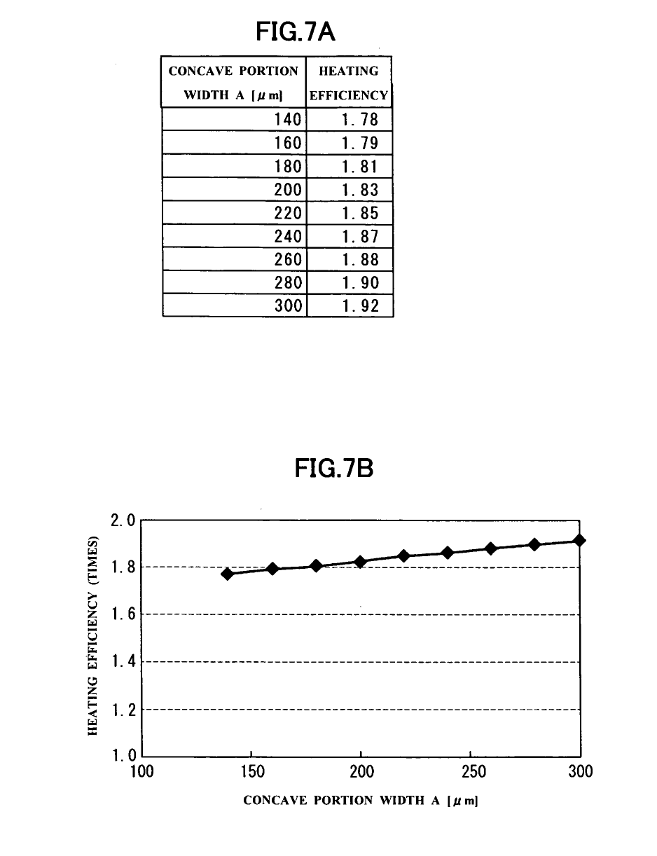

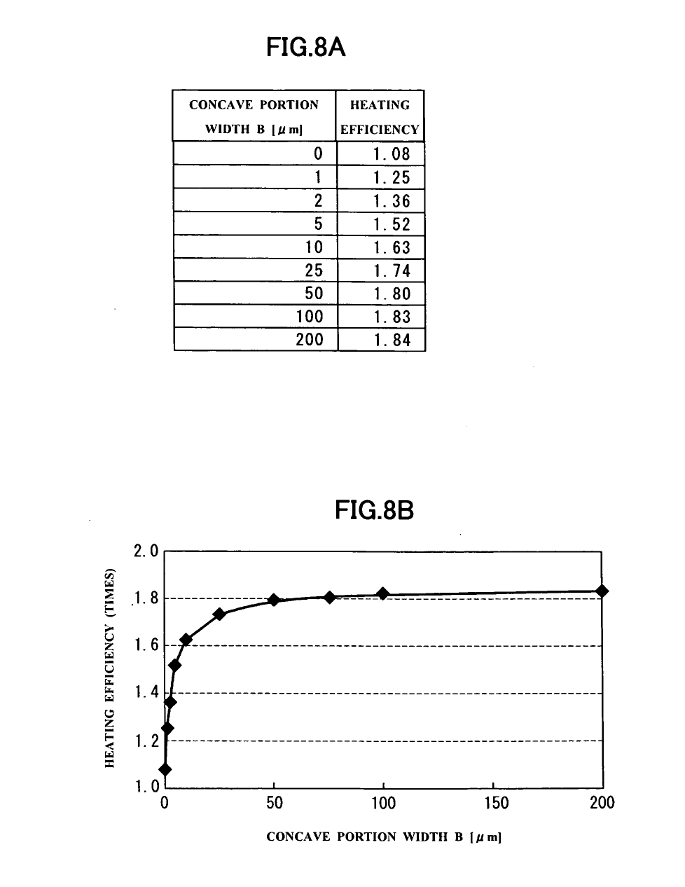

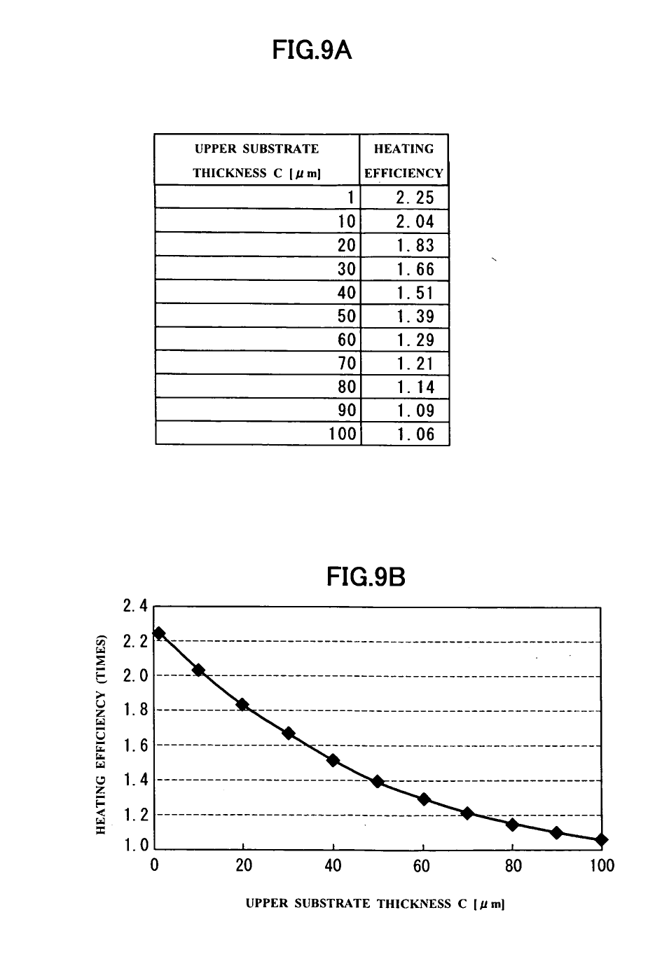

As shown in FIGS. 7A and 7B, a tendency is found that heating efficiency of the thermal head is increased more as the width dimension (μm) of the concave portion 21 is larger. FIGS. 7A and 7B show heating efficiency in comparison to that of a conventional commonly-used thermal head. The same is applied to FIGS. 8A and 8B and FIGS. 9A and 9B described below.

Further, as shown in FIGS. 8A and 8B, a tendency is found that the heating efficiency of the thermal head is increased more as the depth dimension (μm) of the concave portion 21 is larger. On the other hand, as shown in FIGS. 9A and 9B, a tendency is found that the heating efficiency of the thermal head is reduced as the thickness of the upper substrate 14 is larger.

Accordingly, for example, in the ranking table of the width of the concave portion 21 shown in FIG. 5A, the evaluation point is set higher as an average value (μm) of the width dimensions of the concave portion 21 is larger, and set lower as the average value (μm) is smaller. Further, for example, in the ranking table of the depth of the concave portion 21 shown in FIG. 5B, the evaluation point is set higher as an average value (μm) of the depth dimensions of the concave portion 21 is larger, and set lower as the average value (μm) is smaller.

Further, for example, in the process conditions of the thickness of the upper substrate 14 shown in FIG. 6, the target value (μm) of the thickness of the upper substrate 14 is set larger (thicker) as the total point of the evaluation point of the width dimension and the evaluation point of the depth dimension of the concave portion 21 is higher, and set smaller (thinner) as the total point is lower.

Next, in the bonding step SA4, a glass substrate made of the same material as that of the support substrate 12 is used as the upper substrate 14. A thin glass substrate having a thickness of 100 μm or smaller is difficult to manufacture and handle, and expensive. Thus, instead of bonding an originally thin upper substrate 14 onto the support substrate 12, the upper substrate 14 which is thick enough to be easily manufactured and handled is bonded onto the support substrate 12, and then the upper substrate 14 is processed to a desired thickness in the thinning step SA5 (Step SA4).

In the bonding step SA4, first, etching masks are all removed from the surface of the support substrate 12, followed by cleaning. Then, the upper substrate 14 is laminated to the surface of the support substrate 12 so as to close all of the concave portions 21. For example, the upper substrate 14 is directly laminated to the support substrate 12 at room temperature without using an adhesive layer.

The one surface of the support substrate 12 is covered with the upper substrate 14 to close the opening of each of the concave portions 21, to thereby form a plurality of cavity portions 23 between the support substrate 12 and the upper substrate 14. In this state, the laminated support substrate 12 and upper substrate 14 are subjected to heat treatment so that the substrates are bonded to each other by thermal fusion (Step SA4). Hereinafter, the resultant substrate obtained by bonding the support substrate 12 and the upper substrate 14 to each other is referred to as a stacked substrate 13.

Next, in the thinning step SA5, based on the process conditions set in the condition setting step SA3 (see FIG. 6), the upper substrate 14 of the stacked substrate 13 is thinned (Step SA5). The thinning of the upper substrate 14 is performed by etching, polishing, or the like. For example, the upper substrate 14 is processed to a thickness approximately ranging from 10 to 50 μm.

For the etching of the upper substrate 14, various types of etching can be used as in the concave portion forming step SA1. Further, for the polishing of the upper substrate 14, for example, chemical mechanical polishing (CMP), which is used for high accuracy polishing for a semiconductor wafer and the like, can be used. Next, in the resistor forming step SA6, the plurality of heating resistors 15 are formed in each of regions of the surface of the upper substrate 14, which are opposed to each of the concave portions 21 (Step SA6). The heating resistors 15 are formed so as to individually straddle each of the cavity portions 23 in a width direction, and are arrayed at predetermined intervals in a longitudinal direction of each of the cavity portions 23.

When the heating resistors 15 are formed, there can be used a thin film forming method such as sputtering, chemical vapor deposition (CVD), or deposition. A thin film is formed from a heating resistor material such as a Ta-based material or a silicide-based material on the upper substrate 14. The thin film is shaped by lift-off, etching, or the like to form the heating resistors 15 having a desired shape.

Next, in the electrode portion forming step SA7, similarly to the resistor forming step SA6, the film formation is performed with use of an electrode material on the upper substrate 14 by using sputtering, deposition, or the like. Then, the film thus obtained is shaped by lift-off or etching, or the electrode material is screen-printed and is, for example, baked thereafter, to thereby form the electrode portions 17A and 17B (Step SA7). Examples of the electrode material which may be used include Al, Al—Si, Au, Ag, Cu, and Pt.

The electrode portions 17A and 17B include: individual electrodes 17A connected to one ends of the respective heating resistors 15 in a direction perpendicular to an array direction thereof; and a common electrode 17B integrally connected to the other ends of all of the heating resistors 15. The heating resistors 15 and the electrode portions 17A and 17B are formed in an arbitrary order. In the patterning of a resist material for the lift-off or etching for the heating resistors 15 and the electrode portions 17A and 17B, the patterning is performed on the photoresist material by using a photomask.

Next, in the protective film forming step SA8, the film formation is performed with use of a protective film material on the upper substrate 14 on which the heating resistors 15 and the electrode portions 17A and 17B are formed, whereby the protective film 19 is formed (Step SA8). Examples of the protective film material which may be used include SiO₂, Ta₂O₅, SiAlON, Si₃N₄, and diamond-like carbon. Further, examples of film forming methods which may be used include sputtering, ion plating, CVD, and the like. The protective film 19 is formed, and hence the heating resistors 15 and the electrode portions 17A and 17B can be protected from abrasion and corrosion.

Next, in the cutting step SA9, the large-size stacked substrate 13 is cut into regions of the individual thermal heads 10 (Step SA9). In this embodiment, twenty-four thermal heads 10 are formed from the single large-size stacked substrate 13.

An action of the thermal head 10 manufactured in this way is described.

When a voltage is selectively applied to the individual electrodes 17A, a current flows through the heating resistors 15 which are connected to the selected individual electrodes 17A and the common electrode 17B opposed thereto, to thereby allow the heating resistors 15 to generate heat. The heat generated by the heating resistors 15 is transferred toward the protective film 19 side to be utilized for printing and the like, and a part of the heat is also transferred toward the support substrate 12 side via the upper substrate 14.

The upper substrate 14 having the heating resistors 15 formed on the surface thereof functions as a heat storage layer that stores the heat generated by the heating resistors 15. On the other hand, the cavity portion 23 disposed between the upper substrate 14 and the support substrate 12 so as to be opposed to the heating resistors 15 functions as a hollow heat-insulating layer that prevents the heat from transferring toward the support substrate 12 side from the heating resistors 15.

Therefore, because of the cavity portion 23, it is possible to prevent a part of the heat generated by the heating resistors 15 from transferring toward the support substrate 12 side via the upper substrate 14. Accordingly, an amount of heat transferring from the heating resistors 15 toward the protective film 19 side to be utilized for printing and the like can be increased to increase use efficiency.

In this case, the heating efficiency is determined by the width and the depth of the concave portion 21, the thickness of the upper substrate 14 (distance from the heating resistor 15 to the cavity portion 23), and the like. In the method of manufacturing a thermal head according to this embodiment, in the thinning step SA5, the upper substrate 14 is processed to a thickness which is set based on the width dimension and the depth dimension of the concave portion 21. Accordingly, the fluctuations in width dimension and depth dimension among the concave portions 21 can be cancelled through adjustment to the thickness of the upper substrate 14. This reduces the occurrence of a failure, and thus a plurality of thermal heads 10 having high heating efficiency and stable quality can be manufactured.

The embodiment of the present invention can be modified as follows.

For example, in the embodiment of the present invention, in the condition setting step SA3, the evaluation points of the width and the depth of the concave portion 21 are used to set the process conditions of the upper substrate 14. Alternatively, however, based on measurement values of the width dimension and the depth dimension of the concave portion 21, the following expression may be used to set the process conditions (appropriate thickness c (μm) of the upper substrate 14):

c=ln(e^{-0.0084×c}×(1−0.0005×(a−A)+(0.0055×b^{-0.69})×(b−B)))/−0.0084

where A is a basic design value (μm) of the width of the concave portion 21, B is a basic design value (μm) of the depth of the concave portion 21, “a” is an actual measurement value (μm) of the width of the concave portion 21, and b is an actual measurement value (μm) of the depth of the concave portion 21.

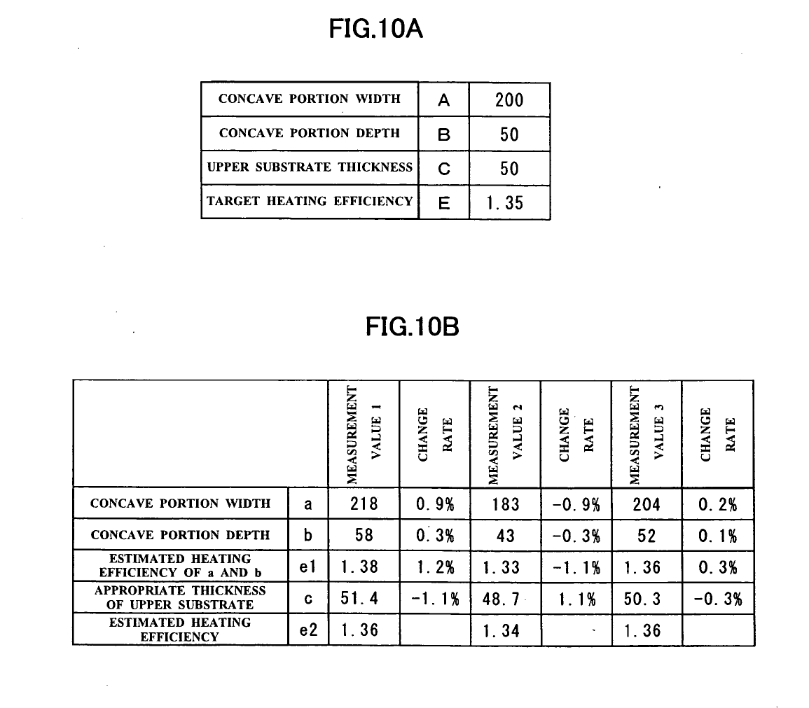

For example, as shown in FIG. 10A, the basic design value A of the width of the concave portion 21 is set to 200 (μm), the basic design value B of the depth of the concave portion 21 is set to 50 (μm), a basic design value C of the thickness of the upper substrate 14 is set to 50 (μm), and target heating efficiency E is set to 1.35 (times). As shown in FIG. 10B, at a point (measurement value 1), when the actual measurement value “a” of the width of the concave portion 21 is 218 (μm) and the actual measurement value b of the depth thereof is 58 (μm), from the above-mentioned expression, the appropriate thickness c of the upper substrate 14 is 51.4 (μm).

Similarly, at another point (measurement value 2), when the actual measurement value “a” of the width of the concave portion 21 is 183 (μm) and the actual measurement value b of the depth of the concave portion 21 is 43 (μm), the appropriate thickness c of the upper substrate 14 is 48.7 (μm). Further, at another point (measurement value 3), when the actual measurement value “a” of the width of the concave portion 21 is 204 (μm) and the actual measurement value b of the depth of the concave portion 21 is 52 (μm), the appropriate thickness c of the upper substrate 14 is 50.3 (μm).

In this way, the above-mentioned expression may be used to set the appropriate thickness of the upper substrate 14, that is, a target value (μm) of the upper substrate 14 in the thinning step SA5.

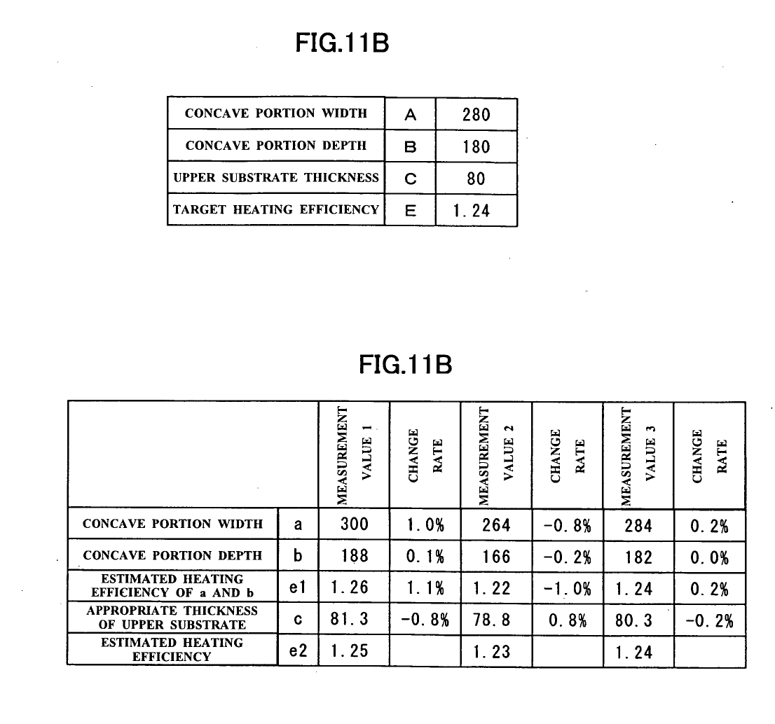

Further, as another example, as shown in FIG. 11A, the basic design value A of the width of the concave portion 21 is set to 280 (μm), the basic design value B of the depth of the concave portion 21 is set to 180 (μm), and the target heating efficiency E is set to 1.24 (times). In this case, as shown in FIG. 11B, at a point (measurement value 1), the appropriate thickness c of the upper substrate 14 is 81.3 (μm) from the above-mentioned expression. Further, at another point (measurement value 2), the appropriate thickness c of the upper substrate 14 is 78.8 (μm). Further, at another point (measurement value 3), the appropriate thickness c of the upper substrate 14 is 80.3 (μm).

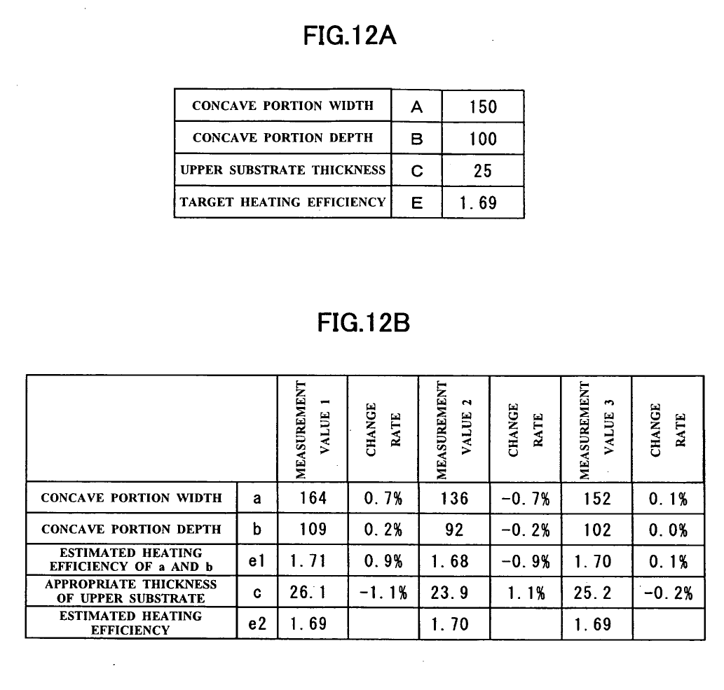

Further, for example, as shown in FIG. 12A, the basic design value A of the width of the concave portion 21 is set to 150 (μm), the basic design value B of the depth of the concave portion 21 is set to 100 (μm), and the target heating efficiency E is set to 1.69 (times). In this case, as shown in FIG. 12B, at a point (measurement value 1), the appropriate thickness c of the upper substrate 14 is 26.1 (μm) from the above-mentioned expression. Further, at another point (measurement value 2), the appropriate thickness c of the upper substrate 14 is 23.9 (μm). Further, at another point (measurement value 3), the appropriate thickness c of the upper substrate 14 is 25.2 (μm).

As described above, by using the above-mentioned expression to set the process conditions of the upper substrate 14, the thickness of the upper substrate 14 can be adjusted more accurately so that the fluctuations in width dimension among the concave portions 21 can be cancelled with good accuracy.

Hereinabove, the embodiment of the present invention has been described in detail with reference to the accompanying drawings. However, specific structures of the present invention are not limited to the embodiment and encompass design modifications and the like without departing from the gist of the present invention.

For example, in the above-mentioned embodiment, the upper substrate 14 is processed in units of a large-size stacked substrate 13. However, the upper substrate 14 may be processed to a thickness which is set for each thermal head 10 by measuring the dimensions of the concave portions 21 for the individual thermal heads 10. In this way, thermal heads 10 with more uniform quality can be manufactured. Further, the thermal heads 10 may be individually manufactured by using support substrates 12 and upper substrates 14 which are cut into pieces in advance for the individual thermal heads 10.

Further, in the above-mentioned embodiment, in the condition setting step SA3, the thickness of the upper substrate 14 is set based on both of the width and the depth of the concave portion 21. Alternatively, however, the thickness of the upper substrate 14 may be set based on one of the width and the depth of the concave portion 21.

Further, in the above-mentioned embodiment, in the concave portion forming step SA1, the concave portion 21 is formed in the support substrate 12. However, it is only necessary to form the concave portion 21 in at least one of the support substrate 12 and the upper substrate 14. For example, the concave portion may be formed in one surface of the upper substrate 14, or the concave portions may be formed in both of the support substrate 12 and the upper substrate 14.

Further, in the above-mentioned embodiment, in the bonding step SA4, the support substrate 12 and the upper substrate 14 are bonded to each other by thermal fusion. Alternatively, however, for example, the support substrate 12 and the upper substrate 14 may be bonded to each other by an extremely thin adhesive layer or by anodic bonding. Bonding by a thick adhesive layer is not desirable in terms of thermal efficiency.

Further, in the above-mentioned embodiment, the bonding step SA4 is performed after the measuring step SA2. However, in the case where a non-contact laser displacement meter is used, it is also possible to measure the width and the depth of the concave portion 21 after the bonding step. Therefore, in this case, the measuring step and the condition setting step may be performed after the bonding step and immediately before the thinning step. The order of steps in this case is advantageous in terms of manufacturing control.

What is claimed is:

1. A method of manufacturing a thermal head, comprising:
forming a groove portion, which is opened in one surface of at least one of a first substrate and a second substrate to be disposed on the first substrate in a stacked state, the first substrate and the second substrate each being of a plate shape;
measuring a width dimension of the groove portion formed in the forming of the groove portion;
bonding the first substrate and the second substrate to each other in the stacked state so as to close an opening of the groove portion formed in the forming of the groove portion;
thinning the second substrate, which is bonded onto the first substrate in the bonding, to a thickness set based on the width dimension of the groove portion measured in the measuring; and
forming a heating resistor on a surface of the second substrate, which is thinned in the thinning, in a region opposed to the groove portion.

2. A method of manufacturing a thermal head, comprising:
forming a groove portion, which is opened in one surface of at least one of a first substrate and a second substrate to be disposed on the first substrate in a stacked state, the first substrate and the second substrate each being of a plate shape;
measuring a depth dimension of the groove portion formed in the forming of the groove portion;
bonding the first substrate and the second substrate to each other in the stacked state so as to close an opening of the groove portion formed in the forming of the groove portion;
thinning the second substrate, which is bonded onto the first substrate in the bonding, to a thickness set based on the depth dimension of the groove portion measured in the measuring; and
forming a heating resistor on a surface of the second substrate, which is thinned in the thinning, in a region opposed to the groove portion.

3. A method of manufacturing a thermal head, comprising:
forming a groove portion, which is opened in one surface of at least one of a first substrate and a second substrate to be disposed on the first substrate in a stacked state, the first substrate and the second substrate each being of a plate shape;
measuring a width dimension and a depth dimension of the groove portion formed in the forming of the groove portion;
bonding the first substrate and the second substrate to each other in the stacked state so as to close an opening of the groove portion formed in the forming of the groove portion;
thinning the second substrate, which is bonded onto the first substrate in the bonding, to a thickness set based on the width dimension and the depth dimension of the groove portion measured in the measuring; and
forming a heating resistor on a surface of the second substrate, which is thinned in the thinning, in a region opposed to the groove portion.
